(19) United States
(12) Patent Application Publication
(10) Pub. No.: US 2015/0066604 A1
(43) Pub. Date: Mar. 5, 2015

(54) FARE PAYMENT METHOD AND APPARATUS THEREOF

(71) Applicant: SAMSUNG SDS CO., LTD., Seoul (KR)

(72) Inventors: Jae Hun JEONG, Seongnam-si (KR); Tae Wook KANG, Seongnam-si (KR); Weon Young YOUN, Seongnam-si (KR)

(73) Assignee: SAMSUNG SDS CO., LTD., Seoul (KR)

(21) Appl. No.: 14/470,437

(22) Filed: Aug. 27, 2014

(30) Foreign Application Priority Data
Aug. 27, 2013 (KR) 10-2013-0101857

(51) Int. Cl. G06Q 20/14; G06Q 50/30; G06Q 20/40; G06Q 20/34

(52) U.S. Cl. CPC G06Q 20/145; G06Q 20/34; G06Q 50/30; G06Q 20/40
USPC 705/13

(57) ABSTRACT

Provided are a fare payment method and apparatus thereof, for paying fares by authorizing card transaction by allowing a plurality of terminals to share card transaction history information. The fare payment method includes receiving information on a connection to one selected as a main terminal among a plurality of terminals connected to one another through a network, and outputting a signal in response to a transaction request from a card user to the card user based on information on a card transaction history received from the main terminal when a communication between the main terminal and a center computer in charge of a card transaction authorization process is interrupted.

### CROSS-REFERENCE TO RELATED APPLICATION

This application claims priority from Korean Patent Application No. 10-2013-0101857 filed on Aug. 27, 2013 in the Korean Intellectual Property Office, and all the benefits accruing therefrom under 35 U.S.C. 119, the contents of which in its entirety are herein incorporated by reference.

### BACKGROUND

1. Field of the Invention

The present invention relates to a fare payment method and apparatus thereof, and more particularly to a fare payment method and apparatus thereof, for paying fares by authorizing card transaction by allowing a plurality of terminals to share card transaction history information.

2. Description of the Related Art

In an account based payment system or an open payment system, no data is recorded on a card on which a transaction request is made. In order to authorize a card transaction, a terminal having received the transaction request transmits a card transaction authorization request to a center computer, and the center computer determines whether to authorize or unauthorize the card transaction and transmits a response to the card transaction authorization request to the terminal.

Although the terminal and the center computer are connected to each other through a network, a communication state of the network may be interrupted. In a case where a communication between the terminal and the center computer is interrupted, since the terminal has invalid card transaction history information that is not synchronized with another terminal adjacent thereto, a card to be unauthorized may be unwantedly authorized.

Korean Patent Publication No. 2009-0066149 discloses a payment method and system including a terminal and an application server executing for payment.

### SUMMARY

The present invention provides a fare payment method for paying fares by authorizing card transaction by allowing a plurality of terminals to share card transaction history information.

The present invention also provides a fare payment apparatus for paying fares by authorizing card transaction by allowing a plurality of terminals to share card transaction history information.

These and other objects of the present invention will be described in or be apparent from the following description of the preferred embodiments.

According to an aspect of the present invention, there is provided a fare payment method including receiving information on a connection to one selected as a main terminal among a plurality of terminals connected to one another through a network, and outputting a signal in response to a transaction request from a card user to the card user based on information on a card transaction history received from the main terminal when a communication between the main terminal and a center computer in charge of a card transaction authorization process is interrupted.

According to another aspect of the present invention, there is provided a fare payment method including checking a communication state with a center computer in charge of a card transaction authorization process, when the communication state with the center computer is normal, receiving card transaction history information from the center computer, when a communication with the center computer, receiving the card transaction history information from a main terminal pre-configured to collect transaction information for a plurality of terminals, outputting a response to a transaction request based on the received card transaction history information, and transmitting new card transaction history information created according to the response to the main terminal and the center computer.

According to still another aspect of the present invention, there is provided a fare payment apparatus including a transaction request information generating unit generating information on a transaction request according to the transaction request based on an open payment, a main terminal information recording unit storing information on a connection to one selected as a main terminal among a plurality of terminals connected to one another through a network, and a transaction processing unit outputting a signal in response to a transaction request from a card user to the card user based on information on a card transaction history received from the main terminal when a communication between the main terminal and a center computer in charge of a card transaction authorization process is interrupted.

### BRIEF DESCRIPTION OF THE DRAWINGS

The above and other features and advantages of the present invention will become more apparent by describing in detail preferred embodiments thereof with reference to the attached drawings in which:

FIG. 1 is a schematic diagram of a conventional fare payment system including a plurality of terminals;

FIG. 2 illustrates a fare payment executing procedure in the conventional fare payment system shown in FIG. 1;

FIG. 3 illustrates a fare payment executing procedure when a network communication is interrupted in the conventional fare payment system shown in FIG. 1;

FIG. 4 is a schematic diagram of a fare payment system according to an embodiment of the present invention;

FIG. 5 illustrates a database table storing information on card transaction histories of a plurality of terminals;

FIG. 6 illustrates a fare payment executing procedure in a fare payment method according to an embodiment of the present invention;

FIG. 7 illustrates a fare payment executing procedure in a fare payment method according to another embodiment of the present invention;

FIGS. 8 and 9 are flowcharts illustrating the fare payment executing procedure shown in FIG. 6;

FIG. 10 illustrates a process of selecting a main terminal in the fare payment executing procedure shown in FIG. 6;

FIG. 11 is a schematic diagram of a fare apparatus according to an embodiment of the present invention; and

FIG. 12 is a partially schematic diagram of a main terminal in which a fare payment method according to an embodiment of the present invention is implemented.

### DETAILED DESCRIPTION OF THE EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

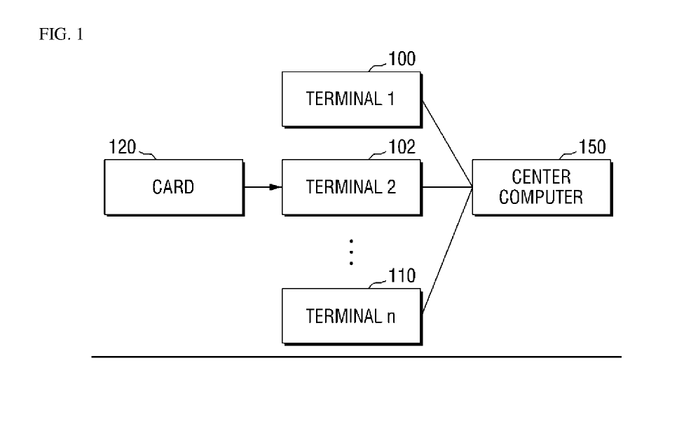

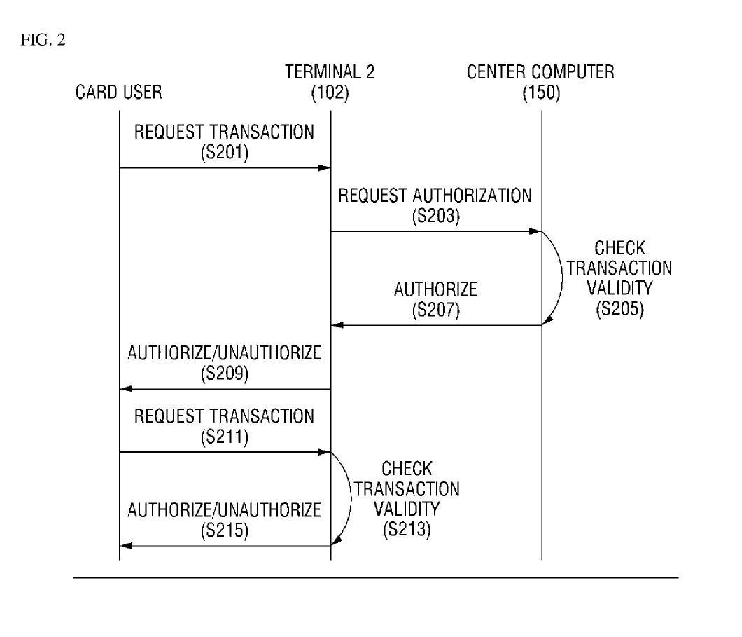

FIG. 1 is a schematic diagram of a conventional fare payment system including a plurality of terminals and FIG. 2 illustrates a fare payment executing procedure in the conventional fare payment system shown in FIG. 1.

Referring to FIG. 1, the fare payment system may include a plurality of terminals 100, 102 and 110 and a center computer 150. The plurality of terminals 100, 102 and 110 may be connected to the center computer 150 through a network.

Referring to FIG. 2, a card user may issue a transaction request to the terminal 102 (S201). For example, the card user tags a card on the terminal 102 to generate the transaction request, and the terminal 102 having received the transaction request may transmit an authorization request for the card transaction to the center computer 150 (S203). The center computer 150 receives the authorization request, and decides whether to approve the authorization request or not (S205), and outputs a response indicative of authorization or unauthorization to the terminal 102 (S207). Meanwhile, the terminal 102 having received the transaction request may not transmit the authorization request for the card transaction to the center computer 150 but may directly determine whether to authorize the card transaction (that is, check transaction validity) based on the card transaction history information stored in the terminal 102 (S213). The response indicative of authorization or unauthorization to the terminal 102 may be output to the terminal 102 (S215).

If the terminal 102 outputs the response indicative of authorization or unauthorization, new card transaction history information is created according to the response. For example, the new card transaction history information may indicate that a card used in the terminal 102 cannot be used in the future (that is, the card should be rejected.). The new card transaction history information may become reference data in determining whether to authorize or unauthorized a subsequent transaction request. The new card transaction history information may be shared by the center computer 150.

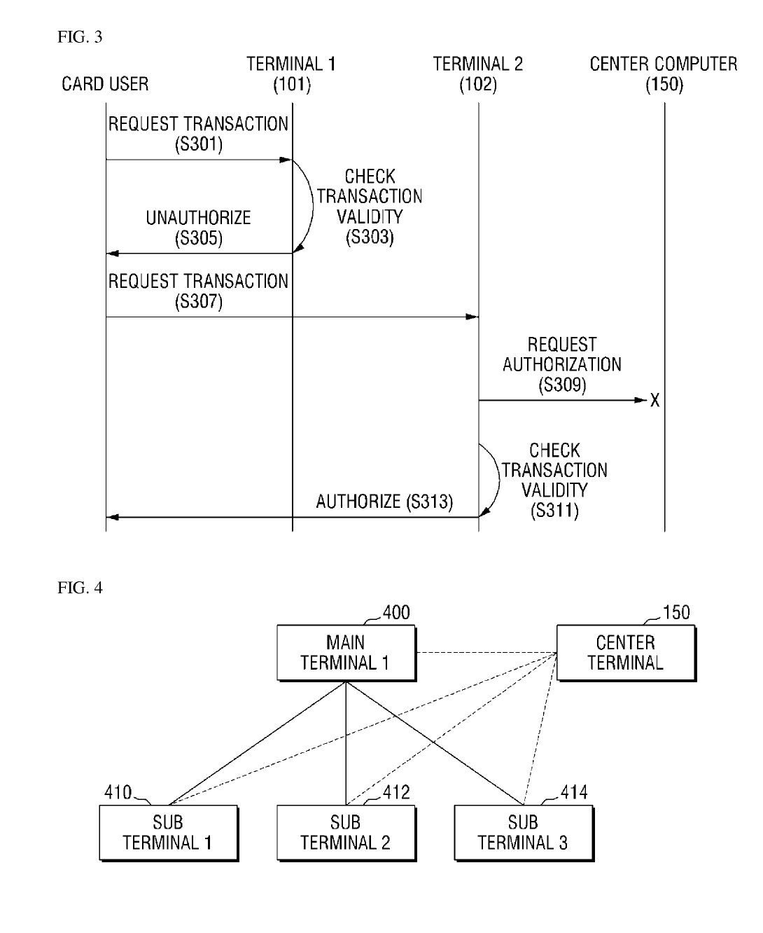

FIG. 3 illustrates a fare payment executing procedure when a network communication is interrupted in the conventional fare payment system shown in FIG. 1.

Referring to FIG. 3, the card user may issue a transaction request to the terminal 100 (S301). The terminal 100 having received the transaction request may communicated with the center computer 150 or may decide transaction validity for itself (S303), and may output a response indicative of unauthorization for the transaction request (S305).

Thereafter, when the card user tags the card to the terminal 102 to create a transaction request (S307), a communication between the terminal 102 and the center computer 150 is interrupted, so that an authorization request may not be issued to the center computer 150 (S309). Therefore, the terminal 102 may determined whether to authorize a transaction based on the card transaction history information owned by the terminal 102 itself (S311). When a communication between the terminal 102 and the center computer 150 is interrupted, since the card transaction history information created in the terminal 100 is not shared by the terminal 102, the terminal 102 may authorize a card to be unauthorized (S313). In order to overcome the problems, even when the communication between the terminal 102 and the center computer 150 is interrupted, it is necessary to share transaction information between the terminal 100 and the terminal 102.

FIG. 4 is a schematic diagram of a fare payment system according to an embodiment of the present invention.

Referring to FIG. 4, the fare payment system according to an embodiment of the present invention may include a main terminal 400, sub terminals 410, 412 and 414 and a center computer 150.

The main terminal 400 is a terminal that collects pieces of card transaction history information associated with the sub terminals 410, 412 and 414 constituting the fare payment system and manages the same. In some embodiments of the present invention, the main terminal 400 and the sub terminals 410, 412 and 414 may be, for example, transit terminals installed in a station or within a transportation system, such as a bus.

The main terminal 400 may be selected in the following manner. In the fare payment method according to an embodiment of the present invention, a terminal having a largest number of adjacent terminals directly connected to a single link on the network, among the plurality of terminals, may be selected as the main terminal 400. In the fare payment method according to another embodiment of the present invention, a terminal having highest stability, among the plurality of terminals, may be selected as the main terminal 400 by evaluating stability of a connected state between each of the terminals and the center computer 150. For example, a terminal having the smallest number of times the connection between the terminal and the center computer 150 is interrupted for a predetermined period of time may be selected as the main terminal 400. Alternatively, a terminal having highest stability may be selected as the main terminal 400 by referring to a table in which pieces of data produced by quantifying stability of the communication state.

Meanwhile, the main terminal 400 may have all of functions of the sub terminals 410, 412 and 414, that is, intrinsic functions of receiving a transaction request from the card user and issuing an authorization request to the center computer 150, but aspects of the present invention are not limited thereto. In some embodiments of the present invention, the main terminal 400 may be implemented as a dedicated terminal configured to manage pieces of card transaction history information associated with the sub terminals 410, 412 and 414. For ease of explanation, the main terminal 400 and the sub terminals 410, 412 and 414 will be separately described. However, in embodiments in which the main terminal 400 is not implemented as dedicated terminal, since the main terminal 400 has the same functions as those of the sub terminals 410, 412 and 414, it is evident that the main terminal 400 also operates as a sub terminal.

The main terminal 400, the sub terminals 410, 412 and 414 and the center computer 150 may be connected to each other through a network. According to some embodiments of the present invention, the network may be a wireless network, such as WIFI, or a wired network, such as LAN, but not limited thereto. In particular, in the fare payment system according to an embodiment of the present invention, the main terminal 400 and the sub terminals 410, 412 and 414, which are connected to each other through a network, may transmit/receive data between terminals not via the center computer 150. According to some embodiments of the present invention, a mesh-type network may be established between the main terminal 400 and the sub terminals 410, 412 and 414.

Meanwhile, the main terminal 400 and the sub terminals 410, 412 and 414 may be located in geometrically adjacent areas. For example, in the fare payment system according to some embodiments of the present invention, the main terminal 400 and the sub terminals 410, 412 and 414 may be installed in the same station to be adjacent to each other.

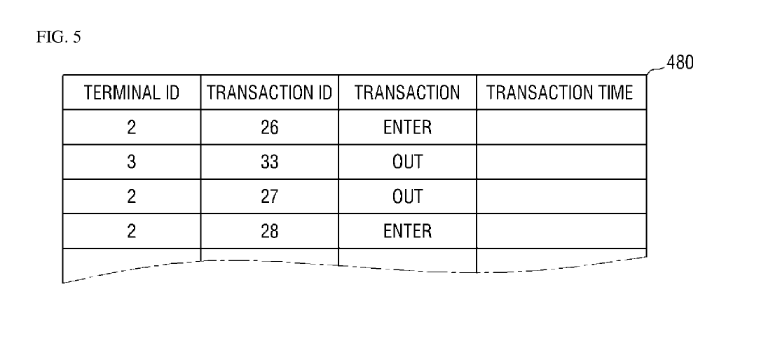

FIG. 5 illustrates a database table storing information on card transaction histories of a plurality of terminals.

The main terminal 400 may collect card transaction history information associated with the sub terminals 410, 412 and 414 constituting the fare payment system and may manage the same using the database table 480. According to some embodiments of the present invention, the database table 480 may have various entities including terminal ID, transaction ID, transaction content, and transaction time. As will later be described, when the sub terminals 410, 412 and 414 may send a request for information on a particular transaction, the main terminal 400 may search the database table 480 to respond to the request. The main terminal 400 may store data of new transaction information received from the sub terminals 410, 412 and 414 and may store the data in the database table 480.

Referring to FIG. 5, the database table 480 indicates a series of transaction information for a card. The card transaction history will now be briefly described. A user entered a gate through a terminal having a terminal ID 2, for example, a gate installed in a station, and left out the gate through a terminal having a terminal ID 3. Next, the user entered the gate through the terminal having a terminal ID 2 and then entered the gate again through the terminal having a terminal ID 2. In the fare payment system according to various embodiments of the present invention, in order to avoid illegal use of a card, consecutive authorization of the same card may be prohibited according to the policies of card issuing companies. For example, in a case where a plurality of terminals are installed within a station, and several terminals adjacent to each other were tagged by the same card almost simultaeneously, consecutive transactions of the card may be considered as illegal use of the card. In this case, card transactions by the user who has consecutively entered the terminal having a terminal ID 2 may be determined as being inappropriate based on the transaction information of the card shown in FIG. 5.

Several terminals adjacent to each other being tagged by the same card almost simultaeneously may mean the several terminals adjacent to each other received transaction authentication request from the same card within a predetermined time duration.

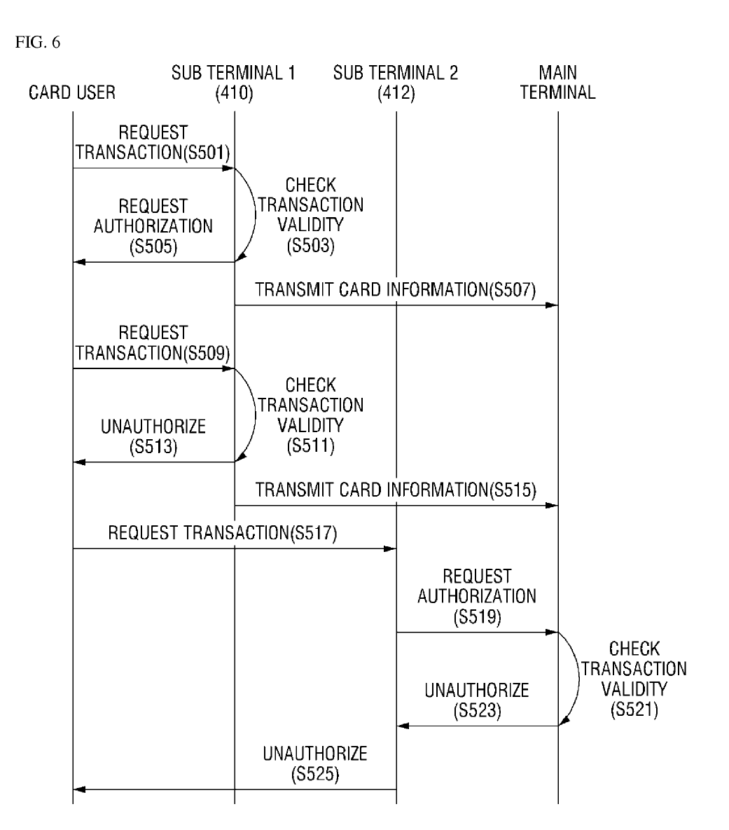

FIG. 6 illustrates a fare payment executing procedure in a fare payment method according to an embodiment of the present invention.

In the embodiment shown in FIG. 6, the sub terminal 410 is capable of communicating with the center computer 150 and the sub terminal 412 is incapable of communicating with the center computer 150.

Referring to FIG. 6, the card user may send a transaction request to the sub terminal 410 (S501). The sub terminal 410 having received the transaction request communicates with the center computer 150 to check transaction validity (S503), and may output a response indicative of authorization for the transaction request (S505). Next, new card transaction history information created according to the response is transmitted to the main terminal 400 (S507) to allow the main terminal 400 to collect and manage the card transaction history information created from the sub terminal 410.

Next, the card user may send a transaction request to the sub terminal 410 once again (S509). The sub terminal 410 having received the transaction request communicates with the center computer 150 to check transaction validity (S511), and outputs a response indicative of unauthorization for the transaction request (S513). Accordingly, new card transaction history information indicating that the card used in the sub terminal 410 cannot be further used and the created new card transaction history information is transmitted to the main terminal 400 (S515).

Next, the card user may send a transaction request to the sub terminal 412 (S517). The sub terminal 412 having received the transaction request checks a communication state between the sub terminal 412 and the center computer 150 connected thereto through the network. As described above, in the embodiment shown in FIG. 6 in which a communication between the sub terminal 412 and the center computer 150 is interrupted, the sub terminal 412 may transmit an authorization request to the main terminal 400 (S519). The main terminal 400 checks transaction validity based on the card transaction history information (S521), and transmits a response to the transaction request (i.e., unauthorization) to the sub terminal 412 (S523), and the sub terminal 412 may output the received response to the user (S525).

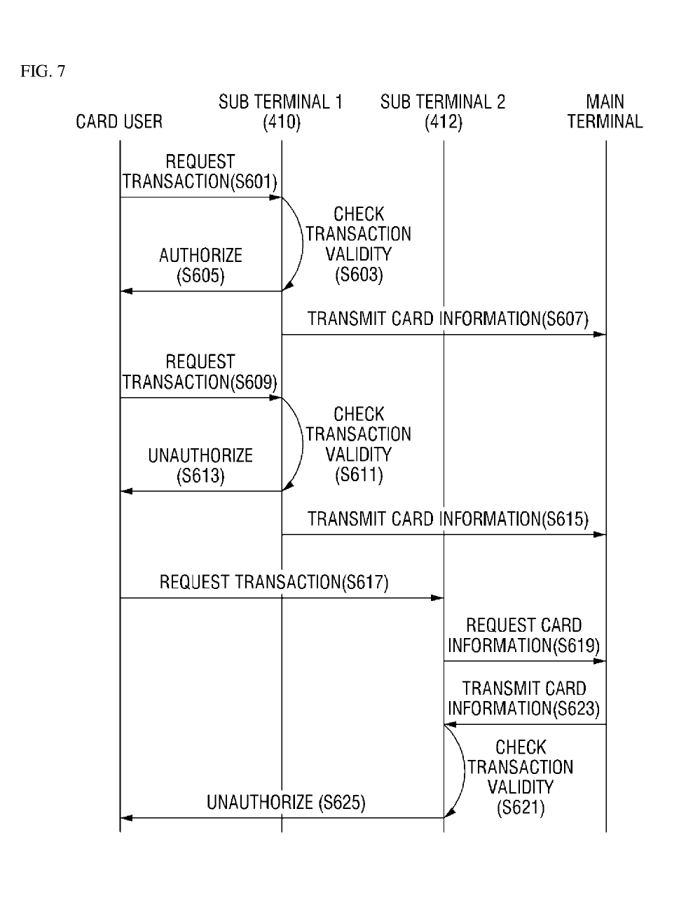

FIG. 7 illustrates a fare payment executing procedure in a fare payment method according to another embodiment of the present invention.

Like in the embodiment shown in FIG. 6, in the embodiment shown in FIG. 7, the sub terminal 410 is capable of communicating with the center computer 150 and the sub terminal 412 is incapable of communicating with the center computer 150.

Since the content of steps S601 to S615 is the same as that of steps S501 to S515 shown in FIG. 6, repeated descriptions thereof will be omitted.

The card user may send a transaction request to the sub terminal 412 (S617). The sub terminal 412 having received the transaction request checks a communication state between the sub terminal 412 and the center computer 150 connected thereto through the network. As described above, in the embodiment shown in FIG. 7 in which a communication between the sub terminal 412 and the center computer 150 is interrupted, the sub terminal 412 may transmit a card information request to the main terminal 400 (S619). The main terminal 400 transmits transaction information of the card to the sub terminal 412 (S621), the sub terminal 412 checks transaction validity based on the card transaction history information received from the main terminal 400 (S621), and outputs a response for the transaction request (in this case, a response indicative of unauthorization) to the card user (S625).

The embodiment shown in FIG. 6 and the embodiment shown in FIG. 7 are different from each other in the following point. That is to say, in the embodiment shown in FIG. 6, the main terminal 400 checks the transaction validity and the sub terminal 412 just transmits the determination result of the main terminal 400 to the user, while in the embodiment shown in FIG. 7, the sub terminal 412 checks the transaction validity and the main terminal 400 just transmits the card transaction history information to the sub terminal 412.

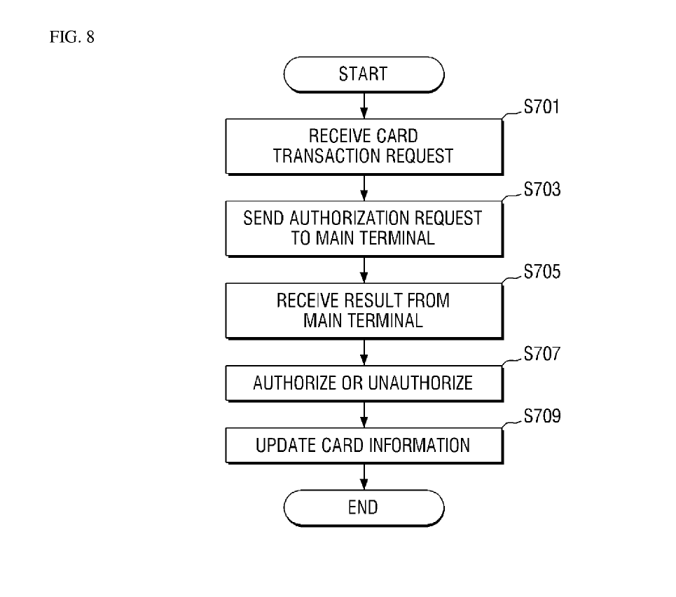

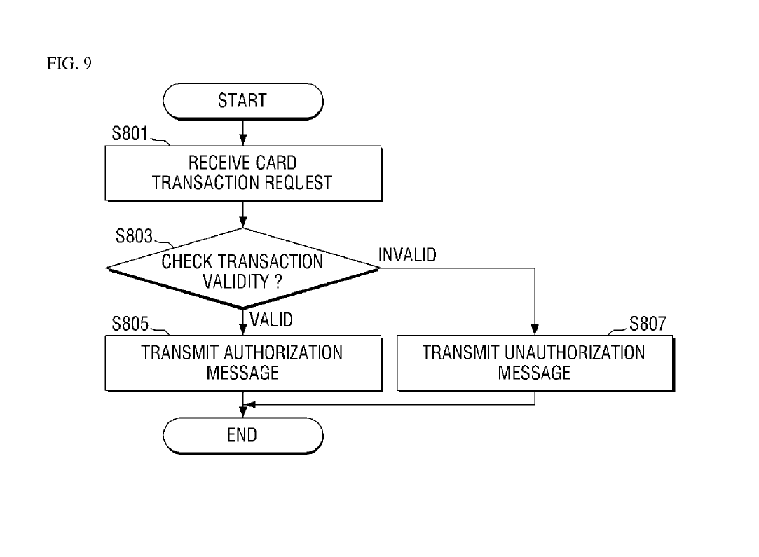

FIGS. 8 and 9 are flowcharts illustrating the fare payment executing procedure shown in FIG. 6.

Referring to FIG. 8, a terminal may receive a transaction request from a user (S701). The terminal having received the transaction request checks a communication state between the terminal and the center computer 150 connected thereto through the network. If the communication between the terminal and the center computer 150 is interrupted, the terminal transmits an authorization request or a card information request to the main terminal 400 and may receive a result thereof (S705). Thereafter, the terminal may output a response indicative of authorization or unauthorization to the user according to the received result (S707) and transmits new card information created according to the response to the main terminal 400 or the center computer 150 to update the card transaction history information (S709).

Here, when the communication with the center computer 150 is interrupted, the new card transaction history information is transmitted only to the main terminal 400, and the new card transaction history information received by the main terminal 400 may be transmitted to the center computer 150. Thereafter, the main terminal 400 and the center computer 150 may perform data synchronization for the card transaction history information.

Referring to FIG. 9, a terminal may receive a transaction request from a user (S801), the terminal having the transaction request may check transaction validity of a card transaction (S803). If a card transaction is determined as being invalid, like in a case where transaction requests using a single card have occurred in terminals adjacent to each other, the terminal may transmit a message indicative of unauthorization to the user (S807). Unlikely, if a card transaction is determined as being valid, the terminal may transmit a message indicative of authorization to the user (S805). As described above, transaction validity may be determined by the center computer 150 or the main terminal 400. Alternatively, transaction validity may also be determined by the sub terminals 410, 412 and 414 in the fare payment method according to some embodiments of the present invention.

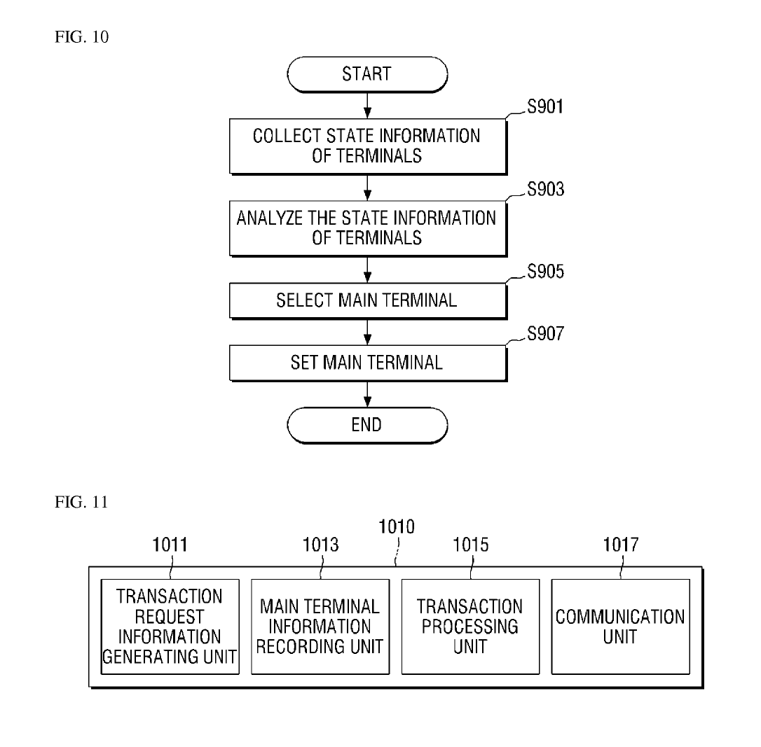

FIG. 10 illustrates a process of selecting a main terminal in the fare payment executing procedure shown in FIG. 6.

The main terminal 400 may be selected in the same manner as in the method described with reference to FIG. 4. In order to select the main terminal 400 in the same manner as in the method described with reference to FIG. 4, first, pieces of state information of a plurality of terminals are collected (S901). Here, the state information may include information on the number of adjacent terminals directly connected to a single link on a network for each terminal and the number of times a communication with the center computer 150 is interrupted for a predetermined period of time. Next, the collected pieces of the state information are analyzed and the main terminal 400 is selected (S903, S904). For example, based on the state information, a terminal having a largest number of adjacent terminals directly connected to a single link on the network may be selected as the main terminal 400. Alternatively, a terminal having the smallest number of times communication with the center computer 150 is interrupted for a predetermined period of time may be selected as the main terminal 400. After the main terminal 400 is selected in such a manner, information of the main terminal 400 is set with respect to the respective terminals 400, 410, 412 and 414 (S907). For example, connection information, including address information of the selected main terminal 400, may be stored as information for setting configurations of the respective terminals 400, 410, 412 and 414. In some embodiments of the present invention, a system manager may manually set the connection information for the main terminal 400 in the respective terminals 400, 410, 412 and 414. The respective terminals 400, 410, 412 and 414 may also receive the connection information for the main terminal 400 through a network and may set the received connection information automatically, without manual configuration of a system manager.

In some embodiments of the present invention, the operation of selecting the main terminal 400 may be performed periodically or intermittently according to operation policies of the fare payment system. However, when the operation of selecting the main terminal 400 is performed again, address information of the selected new main terminal 400 may be notified the respective terminals 400, 410, 412 and 414 through the network.

FIG. 11 is a schematic diagram of a fare payment apparatus according to an embodiment of the present invention.

Referring to FIG. 11, the fare payment apparatus 1010 according to an embodiment of the present invention may include a transaction request information generating unit 1011 generating information on a transaction request according to the transaction request based on an open payment, a main terminal information recording unit 1013 storing information on a connection to one selected as a main terminal 400 among a plurality of terminals connected to one another through a network, and a transaction processing unit 1015 outputting a signal in response to a transaction request from a card user to the card user based on information on a card transaction history received from the main terminal 400 when a communication between the main terminal and a center computer 150 in charge of a card transaction authorization process is interrupted. In some embodiments of the present invention, the fare payment apparatus 1010 may be a public transportation system boarding gate.

The fare payment apparatus 1010 according to an embodiment of the present invention may further include a communication unit 1017 receiving a signal responsive to the transaction request from an RF card and providing the signal to the transaction request information generating unit 1011, wherein data associated with the response signal is not transmitted to the RF card.

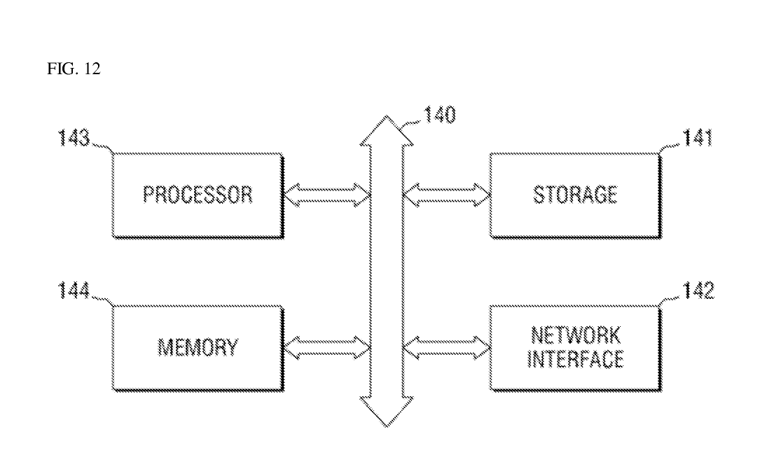

FIG. 12 is a partially schematic diagram of a main terminal in which a fare payment method according to an embodiment of the present invention is implemented. The main terminal 400 may have a configuration as shown in FIG. 12. The main terminal 400 may include a processor 143 executing a command, a storage 141, a memory 144, a network interface 142 for data transmission and reception with respect to an external device, and a data bus 140 connected to the storage 141, the network interface 142, the processor 143 and the memory 144 to establish a data movement path. Program or software codes for implementing the fare payment method according to an embodiment of the present invention may be stored in the memory 144 and executed by the processor 143. Transaction data, including card transaction history information for the sub terminals 410, 412 and 414, may be stored in the storage 141.

As described above, in order to avoid illegal use of a card, consecutive authorization of the same card may be prohibited according to the policies of card issuing companies. For example, in a case where a plurality of terminals are installed within a station, several terminals adjacent to each other were tagged by the same card almost simultaeneously, consecutive transactions of the card may be considered as illegal use of the card. In this case, if a communication between the terminal and the center computer is interrupted, the terminal may not be notified of information associated with card transactions having occurred in adjacent terminals while the communication is interrupted, so that the illegal use of the card may not be appropriately handled. For example, even if the same card has been tagged by several adjacent terminals, such an event may not be notified the terminal and there may be a possibility of authorizing the illegally used card.

According to the present invention, since card transaction history information is shared by a plurality of terminals, even when a communication between a terminal and a center computer is interrupted, an invalid card transaction can be accurately identified, thereby avoiding the problem of illegal use of a card. Further, even when a communication between a terminal and a center computer is interrupted, card services can be offered to users without interruption.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A fare payment method comprising:
receiving information on a connection to one terminal selected as a main terminal among a plurality of terminals connected to one another through a network; and
receiving a card user transaction request;
detecting an interruption in a card transaction authorization process between the main terminal and a center computer in charge of the card transaction authorization;
when the interruption is detected, responding to the card user transaction request by outputting a response signal, for the card user, based on information on a card transaction history received from the main terminal.

2. The fare payment method of claim 1, wherein the main terminal is selected based upon having a largest number, among the plurality of terminals, of adjacent terminals directly connected to a single link on the network.

3. The fare payment method of claim 1, wherein the main terminal is selected based upon having a highest stability, among the plurality of terminals, the stability being evaluated based on a connection state with the center computer.

4. The fare payment method of claim 3, wherein the main terminal is selected based upon having a smallest number of times the connection with the center computer is interrupted for at least a predetermined period of time.

5. The fare payment method of claim 3, wherein the main terminal is selected by referring to a table storing data produced by quantifying stability of the communication state with the center computer.

6. The fare payment method of claim 1, wherein the main terminal is randomly selected terminal from among the plurality of terminals.

7. The fare payment method of claim 1, wherein the plurality of terminals comprises transit terminals of a transit station.

8. The fare payment method of claim 1, wherein the plurality of terminals comprises one or more transit terminals installed in a bus.

9. The fare payment method of claim 1, wherein the outputting of the response signal comprises:
receiving the response signal, in response to the card user transaction request, generated by the main terminal based on the card transaction history information; and
outputting the response signal, received from the main terminal, to the card user.

10. A fare payment method comprising:
receiving a transaction request;
checking a communication state with a center computer in charge of a card transaction authorization process;
when the communication state with the center computer is normal, receiving card transaction history information from the center computer;
when a communication state with the center computer is interrupted, receiving the card transaction history information from a main terminal pre-configured to collect transaction information for a plurality of terminals;
outputting a response to the transaction request based on the received card transaction history information; and
transmitting new card transaction history information, created in accordance with the response, to the main terminal and to the center computer.

11. The fare payment method of claim 8, wherein the transmitting of the new card transaction history information to the main terminal and the center computer wherein, when the communication with the center computer is interrupted, a new card transaction history information is transmitted to the center computer via the main terminal.

12. A fare payment apparatus comprising:
a transaction request information generating unit configured to generate information, on a received transaction request, the transaction request being based on an open payment;
a main terminal information recording unit configured to store information on a connection to a terminal, among a plurality of terminals, selected as a main terminal, the plurality of terminals being connected to one another through a network; and
a transaction processing unit configured to output a signal, in response to the received transaction request, based on card transaction history information;
wherein, when communication with a center computer in charge of a card transaction authorization process, related to the received transaction request, is interrupted, the card transaction history information is obtained from the main terminal.

13. The fare payment apparatus of claim 12, wherein the fare payment apparatus further comprises a public transportation system boarding gate.

14. The fare payment apparatus of claim 12, wherein the main terminal is selected based on having a largest number, among the plurality of terminals, of adjacent terminals directly connected to a single link on the network.

15. The fare payment apparatus of claim 12, wherein the main terminal is selected based upon having a highest stability, among the plurality of terminals, of the stability being evaluated based on a connection state with the center computer.

16. The fare payment apparatus of claim 15, wherein the main terminal is selected based upon having a smallest number of times the connection with the center computer is interrupted for at least a predetermined period of time.

17. The fare payment apparatus of claim 15, wherein the main terminal is selected by referring to a table storing data produced by quantifying stability of the communication state with the center computer.

18. The fare payment apparatus of claim 12, wherein the main terminal is randomly selected terminal from among the plurality of terminals.

19. The fare payment apparatus of claim 12, further comprising a communication unit configured to receive the response signal, in response to the received transaction request, the transaction request being received from an RF card, the communication unit being further configured to provide the response signal to the transaction request information generating unit, wherein at least some of the data associated with the response signal is not transmitted to the RF card.
